(19) United States
(12) Patent Application Publication
(10) Pub. No.: US 2019/0331836 A1
(43) Pub. Date: Oct. 31, 2019

(54) COA ARRAY SUBSTRATE, PREPARATION METHOD THEREOF AND LIQUID CRYSTAL DISPLAY PANEL

(71) Applicant: Xianyang Caihong Optoelectronics Technology Co., Ltd, XIANYANG (CN)

(72) Inventor: YUAN-LIANG WU, XIANYANG (CN)

(21) Appl. No.: 16/361,408

(22) Filed: Mar. 22, 2019

(30) Foreign Application Priority Data
Apr. 29, 2018 (CN) 2018104038487

(51) Int. Cl. G02B 5/20; G02F 1/1368; G02F 1/1362

(52) U.S. Cl. CPC G02B 5/201; G02F 2001/136222; G02F 1/136209; G02F 1/1368

(57) ABSTRACT

The present disclosure relates a GOA array substrate, a preparation method thereof and a liquid crystal display panel. The array substrate includes a substrate; a thin film transistor array layer disposed on the substrate; a color filter layer disposed on the thin film transistor array layer, wherein the color filter layer is provided with a via hole penetrating the color filter layer into the thin film transistor array layer, a surface of the color filter layer is further provided with a vent hole; a second protective layer disposed on the color filter layer; a transparent conductive layer disposed on the via hole and the second protective layer; and a cover layer disposed on the vent hole and the second protective layer. The vent hole provided with a cover layer can prevent the gas remaining in the color filter layer from encountering the influence of high temperature or high pressure.

### FIELD OF THE DISCLOSURE

The present invention relates to the field of liquid crystal display technologies, includes a liquid crystal display panel use a new COA (color filter on array) design and an array substrate process flow.

### BACKGROUND OF THE DISCLOSURE

Liquid crystal display (LCD) has many advantages such as thin body, power saving, and no radiation, and has been widely used. Such as: LCD TV, mobile phone, personal digital assistant (FDA), digital camera, computer screen or laptop screen. A liquid crystal display device generally includes a liquid crystal display panel and a backlight module. The liquid crystal display panel structure mainly includes a Thin Film Transistor Array (TFT Array) substrate, a Color Filter (CF) substrate, and a liquid crystal layer disposed between the two substrates. The working principle is to control the rotation of the liquid crystal molecules of the liquid crystal layer by applying a driving voltage on the two glass substrates and refract the light of the backlight module to generate a picture.

COA (Color-filter on Array) technology is an integrated technology that directly produces a color filter layer on an array substrate. The COA technology can effectively solve the problem of light leakage caused by the alignment deviation in the process of the liquid crystal display device and can significantly increase the display aperture ratio. In the COA preparation technology, since the color filter layer is prepared on the array substrate, the process difficulty is increased. Moreover, gas is left in the preparation of the color filter layer, and these gases form a small molecule gas in a high temperature or high-pressure environment, thereby penetrating the protective layer into the liquid crystal layer.

Please refer to FIG. 1. FIG. 1 is a schematic diagram of a pixel structure provided by the prior art. Although the gas in the color filter layer can be discharged by adding a vent hole on the color filter layer, the gas cannot be completely discharged through the vent hole, resulting in residual gas in the color filter layer. The residual gas will still penetrate into the liquid crystal layer to generate bubbles in a high temperature or high-pressure environment, thereby affecting the display effect and reducing the product yield.

### SUMMARY OF THE DISCLOSURE

Therefore, in order to solve the technical defects and deficiencies of the prior art, the present invention provides a COA array substrate, a preparation method thereof and a liquid crystal display panel.

Specifically, a COA array substrate according to an embodiment of the present invention includes:

a substrate;

a thin film transistor array layer disposed on the substrate;

a color filter layer disposed on the thin film transistor array layer, wherein the color filter layer is provided with a via hole penetrating the color filter layer into the thin film transistor array layer, a surface of the color filter layer is further provided with a vent hole;

a second protective layer disposed on the color filter layer;

a transparent conductive layer disposed on the via hole and the second protective layer; and

a cover layer disposed on the vent hole and the second protective layer.

In an embodiment of the invention, the thin film transistor array layer includes:

a first metal layer disposed on the substrate;

an insulating layer disposed on the substrate and the first metal layer;

a conductor layer disposed on the insulating layer;

a second metal layer disposed on the insulating layer and the conductor layer; and

a first protective layer disposed on the insulating layer, the conductor layer and the second metal layer.

In an embodiment of the invention, the color filter layer includes a red filter layer, a green filter layer, and a blue filter layer.

In an embodiment of the invention, the number of the vent holes is N, where N≥1.

In an embodiment of the invention, the vent holes are equally spaced or unevenly arranged on the surface of the color filter layer.

In an embodiment of the invention, the material of the transparent conductive layer is indium tin oxide or indium zinc oxide.

In an embodiment of the invention, the material of the cover layer is indium tin oxide or indium zinc oxide.

In an embodiment of the invention, the cover layer has a thickness of 400 Å to 800 Å.

One embodiment of the present invention also provides a method for preparing a COA array substrate, including:

selecting a substrate;

forming a thin film transistor array layer on the substrate;

forming a color filter layer on the thin film transistor array layer;

forming a second protective layer on the color filter layer;

forming a via hole penetrating the color filter layer and the second protective layer to the thin film transistor array layer in the color filter layer and the second protective layer, and simultaneously forming a vent hole penetrating the second protective layer to an inner surface of the color filter layer; and

forming a transparent conductive layer on the second protective layer and the via hole while the cover layer is formed on the vent hole and the second protective layer.

One embodiment of the present invention also provides a liquid crystal display panel, including:

a COA array substrate according to any of the above embodiments; and

a display layer located on the COA array substrate.

In an embodiment of the invention, the display layer includes:

a liquid crystal layer disposed on the COA array substrate;

a photoresist gap layer, located in the liquid crystal layer;

a color film transparent conductive layer disposed on the liquid crystal layer and the photoresist gap layer;

a black matrix layer disposed on the color film transparent conductive layer; and

a color filter substrate disposed on the color film transparent conductive layer and the black matrix layer.

The embodiment of the invention has the following advantages:

The vent hole of the proposed COA array substrate of the present invention is provided with a cover layer, which can avoid the gas remaining in the liquid crystal layer forming bubbles after the gas remaining in the color filter layer of the group is further affected by high temperature or high pressure. It can ensure that no bubbles are generated in the liquid crystal layer, thereby ensuring the display effect; at the same time, the cover layer of the invention is prepared by preparing a transparent conductive layer by using a transparent conductive layer preparation material and a process, and does not increase the original preparation process of the COA array substrate, and the preparation process is simple.

Other aspects and features of the present invention will become apparent from the Detailed Description of the Drawing. It should be understood, however, that the drawings are intended for purposes of illustration only and are not intended to. It should be understood that the drawings are not necessarily to scale unless otherwise.

### BRIEF DESCRIPTION OF THE DRAWINGS

The specific embodiments of the present invention will be described in detail below with reference to the accompanying drawings.

FIG. 1 is a schematic diagram of a pixel structure provided by the prior art;

FIG. 2 is a schematic structural diagram of a COA array substrate according to an embodiment of the present invention;

FIG. 3 is a schematic diagram of a pixel structure of a liquid crystal display panel according to an embodiment of the present invention;

FIG. 4 is a schematic flow chart of a method for preparing a COA array substrate according to an embodiment of the present invention;

FIG. 5 is a schematic structural diagram of a liquid crystal display panel according to an embodiment of the present invention.

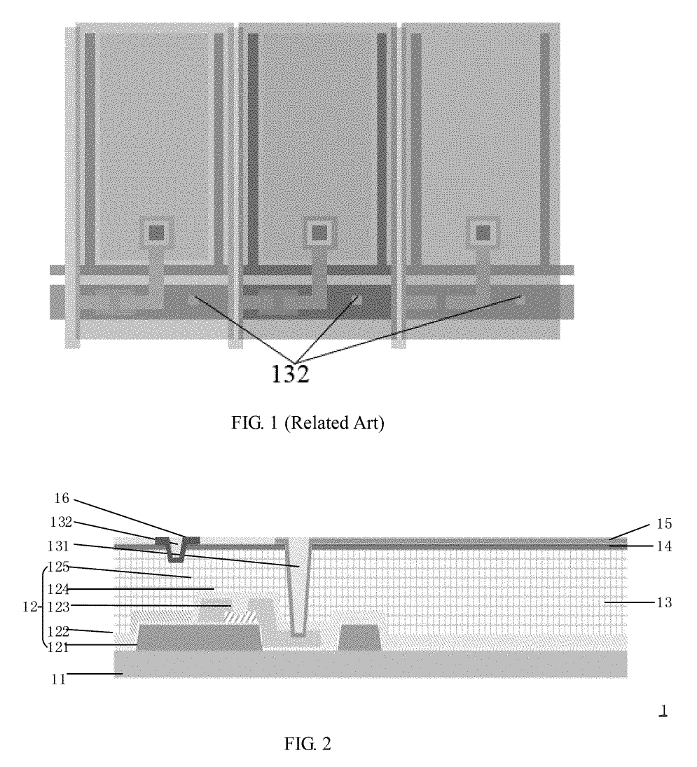

### DETAILED DESCRIPTION OF PREFERRED EMBODIMENTS

The above described objects, features and advantages of the present invention will become more apparent from the aspects of the appended claims.

### Embodiment 1

Referring to FIG. 2, FIG. 2 is a schematic structural diagram of a COA array substrate according to an embodiment of the present invention. Specifically, a COA array substrate proposed in this embodiment includes:

a substrate 11;

a thin film transistor array layer 12 disposed on the substrate 11;

a color filter layer 13 disposed on the thin film transistor array layer 12, wherein the color filter layer 13 is provided with a via hole 131 penetrating the color filter layer 13 into the thin film transistor array layer 12, a surface of the color filter layer 13 is further provided with a vent hole 132;

a second protective layer 14 disposed on the color filter layer 13;

a transparent conductive layer 15 disposed on the via hole 131 and the second protective layer 14; and

a cover layer 16 disposed on the vent hole 132 and the second protective layer 14.

In order to better illustrate the implementation process of the present invention, the COA array substrate is described in detail based on the above embodiments.

The substrate 11 may be one of a glass substrate, a metal substrate, a quartz substrate, or an organic substrate.

The thin film transistor array layer 12 includes a first metal layer 121, an insulating layer 122, a conductive layer 123, a second metal layer 124, and a first protective layer 125.

Specifically, the first metal layer 121 is disposed on the substrate 11, wherein the first metal layer 121 includes a gate region of the thin film transistor, and the first metal layer 121 serves as a scan line of the display panel.

Preferably, the material of the first metal layer 121 is chromium, molybdenum, aluminum or copper or the like.

The insulating layer 122 is disposed on the substrate 11 and the first metal layer 121, and the insulating layer 122 covers the first metal layer 121. Wherein the insulating layer 122 is used to isolate the first metal layer 121 and the second metal layer 124 from the first metal layer 121 and the conductor layer 123.

Preferably, the material of the insulating layer 122 is silicon nitride, silicon oxide, and silicon oxynitride.

Preferably, the material of the first protective layer 125 is silicon nitride, silicon oxide, a combination of silicon nitride and silicon oxide, or a transparent organic resin.

The color filter layer 13 is disposed on the first protective layer 125, the color filter layer 13 is provided with a via hole 131 extending through the color filter layer 13 to the second metal layer 124, a vent hole 132 is disposed on a surface of the color filter layer 13, and the vent hole 132 penetrates through the second protective layer 14, the gas inside the color filter layer 13 can be smoothly discharged through the vent holes 132, reducing the residual amount of gas inside the color filter layer 13, the number of the vent holes 132 is plural, and may be arranged at equal intervals or at an unequal pitch, the depth of the vent hole 132 in the color filter layer 13 can be adjusted according to specific process requirements, and the vent hole 132 can pass through the color filter layer 13.

Preferably, the vent hole 132 is located on the surface of the color filter layer 13 covering the corresponding side of the conductor layer 123.

Preferably, the material of the color filter layer 13 is an organic material, such as a negative photoresist, wherein the color filter layer 13 includes a red filter layer, a green filter layer, and a blue filter layer.

The second protective layer 14 covers the color filter layer 13, the second protective layer 14 is used to isolate the color filter layer 13 and the transparent conductive layer 15, and the second protective layer 14 effectively prevents molecules in the color filter layer 13 from entering the liquid crystal layer 21, wherein the via hole 131 and the vent hole 132 both penetrate the second protective layer 14.

Preferably, the material of the second protective layer 14 is a combination of silicon nitride, silicon oxide, silicon nitride and silicon oxide or a transparent organic resin.

The transparent conductive layer 15 covers the via hole 131, and the transparent conductive layer 15 is in contact with the second metal layer 124 via the via hole 131 penetrating through the first protective layer 125, the color filter layer 13, and the second protective layer 14, the transparent conductive layer 120 includes a pixel electrode that is connected to the drain of the second metal layer 124 through a via hole 131 penetrating through the first protective layer 125, the color filter layer 13, and the second protective layer 14. The transparent conductive layer 15 includes a red sub-pixel, a green sub-pixel, or a blue sub-pixel. Correspondingly, the red sub-pixel corresponds to a red filter layer, the green sub-pixel corresponds to a green filter layer, and the blue sub-pixel corresponds to a blue filter layer.

Preferably, the material of the transparent conductive layer 15 is indium tin oxide (ITO) or indium-doped zinc oxide (IZO).

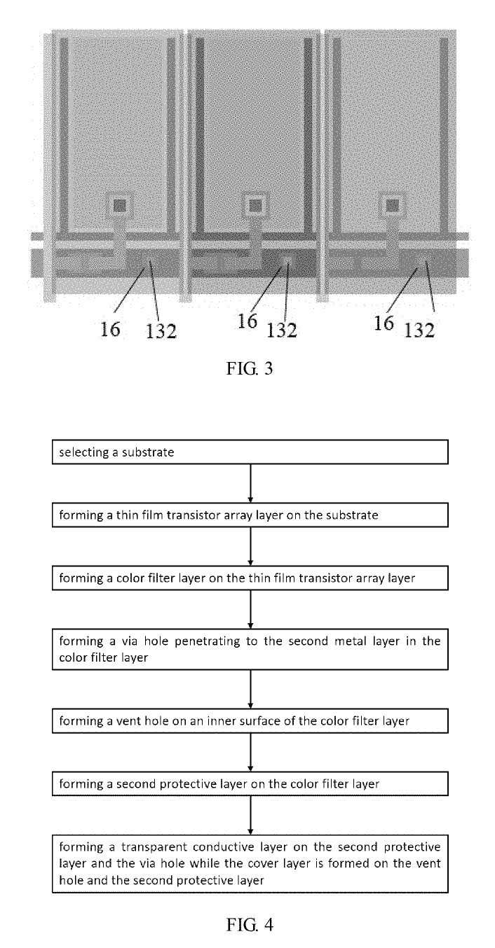

Please refer to FIG. 3, which is a schematic diagram of a pixel structure of a liquid crystal display panel according to an embodiment of the present invention. The cover layer 16 covers the vent holes 132, the number of the cover layers 16 is equal to the number of the vent holes 132, and the cover layer 16 is arranged in the same manner as the vent holes 132.

Preferably, the cover layer 16 has a thickness of 400 Å to 800 Å.

Preferably, the material of the cover layer 16 is indium tin oxide or indium zinc oxide. At the same time as preparing the transparent conductive layer 15, the cover layer 16 can be simultaneously prepared by the process of preparing the transparent conductive layer 15. In this way, not only the cover layer 16 can be covered above the vent hole, but also avoids the influence of high temperature or high pressure after the group is caused, and the gas overflows to form a bubble in the liquid crystal layer, and the preparation process can be simplified, and the cost of preparing the cover layer 16 can be saved.

The vent hole of the proposed COA array substrate of the present invention is provided with a cover layer. After the vent hole of the color filter layer is prepared, the gas in the color filter layer can be made in the subsequent process of preparing the second protective layer. The gas in the color filter layer is released through the vent hole by the action of high temperature, and then the cover layer is covered by the vent hole. The gas remaining in the color filter layer in the subsequent process is prevented from encountering high temperature or high pressure, and the gas overflows to form a bubble in the liquid crystal layer.

### Embodiment 2

Please refer to FIG. 4, FIG. 4 is a schematic flow chart of a method for preparing a COA array substrate according to an embodiment of the present invention. The embodiment of the present invention further provides a method for preparing a COA array substrate, including:

selecting a substrate;

forming a thin film transistor array layer on the substrate;

forming a color filter layer on the thin film transistor array layer;

forming a second protective layer on the color filter layer;

forming a via hole penetrating the color filter layer and the second protective layer to the thin film transistor array layer in the color filter layer and the second protective layer, and simultaneously forming a vent hole penetrating the second protective layer to an inner surface of the color filter layer; and

forming a transparent conductive layer on the second protective layer and the via hole while the cover layer is formed on the vent hole and the second protective layer.

In order to better illustrate the implementation process of the present invention, the method for preparing the COA array substrate is described in detail based on the above embodiments. The method for preparing the COA array substrate includes:

S01, selecting the substrate 11;

S02, forming a thin film transistor array layer 12 on the substrate 11, wherein the thin film transistor array layer 12 includes a first metal layer 121, an insulating layer 122, a conductive layer 123, a second metal layer 124, and a first protective layer 125;

S021, forming a first metal layer 121 on the substrate 11;

Specifically, depositing a first metal layer 121 on the substrate 11 by chemical vapor deposition, and then, after coating the first metal layer 121 on the photoresist, exposing, developing and etching the first metal layer 121 with a mask to form a gate. Wherein, the first metal layer 121 other than the gate portion is etched away in the process.

S022, forming an insulating layer 122 on the first metal layer 121 and the base substrate 11;

Specifically, the insulating layer 122 is formed on the first metal layer 121 and the substrate 11 not covered by the first metal layer 121.

S023, forming a conductor layer 123 on the insulating layer 122;

Specifically, an active layer is formed on the insulating layer 122, and then patterned on the active layer to form an ohmic contact layer. The ohmic contact layer includes a plurality of sources and a plurality of drains, wherein the number of gates matches the number of sources and drains.

S024, forming a second metal layer 124 on the insulating layer 122 and the conductor layer 123;

Specifically, a second metal layer 124 is deposited on the insulating layer 122 and the conductor layer 123 by chemical vapor deposition, after the second metal layer 124 is coated with the photoresist, the second metal layer 124 is exposed, developed, and etched by a mask to form a source and a drain. Wherein the first metal layer other than the source and drain portions is etched away during the process.

S025, forming a first protective layer 125 on the insulating layer 122, the conductive layer 123 and the second metal layer 124;

Specifically, a first protective layer 125 covering the insulating layer 122, the conductor layer 123, and the second metal layer 124 is formed on the insulating layer 122, the conductor layer 123, and the second metal layer 124.

S03, forming a color filter layer 13 on the first protective layer 125;

Specifically, the color filter layer 13 is coated on the first protective layer 125.

S04, forming a second protective layer 14 on the color filter layer 13;

Specifically, the second protective layer 14 is deposited on the surface of the color filter layer 13 using a chemical vapor deposition method.

S05, forming a via hole penetrating the color filter layer 13 and the second protective layer 14 to the thin film transistor array layer 12 in the color filter layer 13 and the second protective layer 14, and simultaneously forming a vent hole penetrating the second protective layer 14 to the inner surface of the color filter layer 14;

Specifically, via holes 131 penetrating the color filter layer 13 and the second protective layer 14 to the second metal layer 124 are formed in the color filter layer 13 and the second protective layer 14 by a dry etching process, the vent hole 132 penetrating the second protective layer 14 to the inner surface of the color filter layer 13 is simultaneously formed by the process of preparing the via hole 131.

S06, forming a transparent conductive layer 15 on the via hole 131 and the second protective layer 14, while forming a cover layer 16 on the vent hole 132 and the second protective layer 14;

Specifically, the transparent conductive layer 15 is formed on the via hole 131 and the second protective layer 14 by a sputtering plating method while forming the cover layer 16 on the vent hole 132 and the second protective layer 14.

In the preparation method of the present invention, while preparing the transparent conductive layer, the coating layer can be simultaneously prepared by the process of preparing the transparent conductive layer. In this way, not only the cover layer can be covered above the vent hole, but also avoids the influence of high temperature or high pressure after the group is caused, and the gas overflows to form a bubble in the liquid crystal layer, and the preparation process can be simplified, and the cost of preparing the cover layer can be saved.

### Embodiment 3

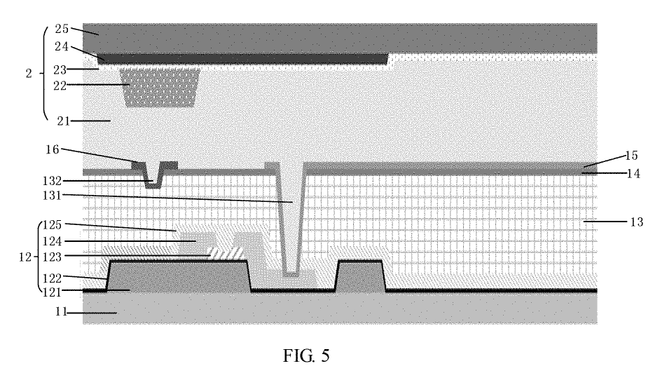

Referring to FIG. 5, FIG. 5 is a schematic structural diagram of a liquid crystal display panel according to an embodiment of the present invention. The liquid crystal display panel includes:

a COA array substrate 1;

and a display layer 2 disposed on the COA array substrate 1.

Further, the display layer 2 includes:

a liquid crystal layer 21 disposed on the COA array substrate 1;

a photoresist gap layer 22, located in the liquid crystal layer 21;

a color film transparent conductive layer 23 disposed on the liquid crystal layer 21 and the photoresist gap layer 22;

a black matrix layer 24 disposed on the color film transparent conductive layer 23; and

a color filter substrate 25 disposed on the color film transparent conductive layer 23 and the black matrix layer 24.

In order to better illustrate the implementation process of the present invention, the structure of the liquid crystal display panel will be described in detail based on the above embodiments.

The liquid crystal layer 21 is specifically located on the vent hole 132, the second protective layer 14, the transparent conductive layer 15 and the cover layer 16.

Preferably, the liquid crystal layer 21 includes a plurality of ferroelectric liquid crystal molecules which are deflected according to an applied voltage to pass or fail light, wherein the ferroelectric liquid crystal molecules have a fast response characteristic.

The photoresist gap layer 22 is used to maintain a spacing between the substrate 11 and the color filter substrate 25.

a color film transparent conductive layer 23 is used to provide an electrode voltage.

Preferably, the material of the color film transparent conductive layer 23 is indium tin oxide or indium zinc oxide.

The black matrix layer 24 includes a plurality of black matrices.

Preferably, the black matrix layer 24 is made of a resin black photoresist.

The color filter substrate 25 is a glass substrate.

The vent hole of the liquid crystal display panel of the present invention is provided with a cover layer, which can prevent the gas remaining in the color filter layer from encountering the influence of high temperature or high pressure, and the gas overflows to form a bubble in the liquid crystal layer. Thereby improving the quality and yield of the liquid crystal display panel.

### Embodiment 4

This embodiment provides a detailed description of the polarity of the preparation method of the liquid crystal display panel based on the above embodiments. The preparation method includes:

S01, forming a liquid crystal layer 21 on the COA array substrate;

Specifically, the liquid crystal layer 21 is formed on the second protective layer 14, the transparent conductive layer 15, and the cap layer 16 by a sputter coating method.

S02, forming a photoresist gap layer 22 on the inner surface of the liquid crystal layer 21;

Specifically, the photoresist gap layer 22 is formed by a dry etching or a wet etching process.

S03, forming a color film transparent conductive layer 23 on the liquid crystal layer 21 and the photoresist gap layer 22;

Specifically, a color film transparent conductive layer 23 is formed on the liquid crystal layer 21 and the photoresist gap layer 22 by a sputter coating method.

S04, forming a black matrix layer 24 on the color film transparent conductive layer 23;

Specifically, a black matrix material is coated on the color film transparent conductive layer 23, and the black matrix material is exposed and developed through a patterned mask to form a black matrix layer 24.

S05, forming a color film substrate 25 on the color film transparent conductive layer 23 and the black matrix layer 24;

The color filter substrate 25 is formed on the color film transparent conductive layer 23 and the black matrix layer 24 by a sputter coating method.

The above is a further detailed description of the present invention in connection with the specific preferred embodiments, and the specific embodiments of the present invention are not limited to the description. It will be apparent to those skilled in the art that the present invention may be made without departing from the spirit and scope of the invention.

What is claimed is:

1. A COA array substrate, comprising:
a substrate;
a thin film transistor array layer disposed on the substrate;
a color filter layer disposed on the thin film transistor array layer, wherein the color filter layer is provided with a via hole penetrating the color filter layer into the thin film transistor array layer, a surface of the color filter layer is further provided with a vent hole;
a second protective layer disposed on the color filter layer;
a transparent conductive layer disposed on the via hole and the second protective layer; and
a cover layer disposed on the vent hole and the second protective layer.

2. The COA array substrate according to claim 1, wherein the thin film transistor array layer comprises:
a first metal layer disposed on the substrate;
an insulating layer disposed on the substrate and the first metal layer;
a conductor layer disposed on the insulating layer;
a second metal layer disposed on the insulating layer and the conductor layer; and
a first protective layer disposed on the insulating layer, the conductor layer and the second metal layer.

3. The COA array substrate according to claim 1, wherein the color filter layer comprises a red filter layer, a green filter layer, and a blue filter layer.

4. The COA array substrate according to claim 1, wherein a number of the vent holes is N, where N≥1.

5. The COA array substrate according to claim 1, wherein a material of the transparent conductive layer is indium tin oxide or indium zinc oxide.

6. The COA array substrate according to claim 1, wherein a material of the cover layer is indium tin oxide or indium zinc oxide.

7. The COA array substrate according to claim 1, wherein the cover layer has a thickness of 400 Å to 800 Å.

8. A method for preparing a COA array substrate, comprising:
selecting a substrate;
forming a thin film transistor array layer on the substrate;
forming a color filter layer on the thin film transistor array layer;
forming a second protective layer on the color filter layer;
forming a via hole penetrating the color filter layer and the second protective layer to the thin film transistor array layer in the color filter layer and the second protective layer, and simultaneously forming a vent hole penetrating the second protective layer to an inner surface of the color filter layer; and
forming a transparent conductive layer on the second protective layer and the via hole while the cover layer is formed on the vent hole and the second protective layer.

9. A liquid crystal display panel comprising:
the COA array substrate according to claim 1; and
a display layer disposed on the COA array substrate.

10. The liquid crystal display panel according to claim 9, wherein the display layer comprises:
a liquid crystal layer disposed on the COA array substrate;
a photoresist gap layer, located in the liquid crystal layer;
a color film transparent conductive layer disposed on the liquid crystal layer and the photoresist gap layer;
a black matrix layer disposed on the color film transparent conductive layer; and
a color filter substrate disposed on the color film transparent conductive layer and the black matrix layer.
